(19) United States
(12) Patent Application Publication
(10) Pub. No.: US 2007/0146576 A1
(43) Pub. Date: Jun. 28, 2007

(54) LIQUID CRYSTAL DISPLAY AND METHOD OF MANUFACTURING THE SAME

(75) Inventors: Rei HASEGAWA, Yokohama-shi (JP); Haruhi Oooka, Kawasaki-shi (JP); Yasuyuki Hotta, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/617,179

(22) Filed: Dec. 28, 2006

(30) Foreign Application Priority Data
Dec. 28, 2005 (JP) P2005-379925

(51) Int. Cl. G02F 1/1333

(52) U.S. Cl. 349/88

(57) ABSTRACT

A liquid crystal display includes a pair of substrates having main surfaces respectively, the main surfaces facing on each other; a polymer layer interposed between the pair of substrates, the polymer layer including a block copolymer having a liquid crystalline side chain and having a periodic structure in a perpendicular direction to the main surfaces; and a controller that controls a light reflectance of the polymer layer by applying a voltage to the polymer layer.

The entire disclosure of Japanese Patent Application No. 2005-379925 filed on Dec. 28, 2005, including specification, claims, drawings and abstract is incorporated herein by reference in its entirety.

### BACKGROUND OF THE INVENTION

1. Field of the Invention

The present invention relates to a liquid crystal display and a method of manufacturing the same.

2. Description of the Related Art

A liquid crystal display of a reflection type has been widely utilized for a watch, a calculator and a small-sized portable apparatus as a display to be operated with a very low consumedpower. A display mode to be used in the liquid crystal display of a reflection type includes a twisted nematic (TN) type, a super twisted nematic (STN) type and an electrically controlled birefringence (ECB) type, and these require a polarizer. When the polarizer is used, however, at least 50% of a light incident on a liquid crystal cell is absorbed by the polarizer. For this reason, it is hard to implement a display of a reflection type which is bright.

As a technique for implementing the display of a reflection type which is bright, there has been known an optical unit (a display) having a layer structure in which a birefringence material (a liquid crystal) and a non-birefringence material (a polymer material) which does not exhibit a birefringence property are disposed like a layer and having a plurality of cycles of the birefringence material and the non-birefringence material (for example, see JP-A-6-308542 (Kokai) and JP-A-7-92483 (Kokai)). In the display, an interference pattern of a laser beam is irradiated on a mixed substance of a light curable resin and a liquid crystal, and the liquid crystal and a polymer material are separated along the interference pattern so that a periodic structure of the birefringence material and the non-birefringence material is formed. By utilizing a change in a refractive index of a liquid crystal layer which is caused by an application of an electric field to the polymer/liquid crystal complex, a transmission and reflection of a light having a specific wavelength is controlled.

As a technique which does not require the polarizer, moreover, there have been known a liquid crystal cell (a display) for superposing a large number of films coated with a liquid crystal and applying a voltage to the complex multilayer film to change a refractive index of the liquid crystal, thereby controlling a transmission/reflection of a light and a method of manufacturing the same (for example, see JP-A-10-228015 (Kokai)). In the display, the refractive index of the liquid crystal layer is changed depending on the applied voltage. With such a structure that the refractive indices of the liquid crystal and the film are coincident with each other in the application of the voltage, therefore, an incident light is transmitted. With such a structure that the refractive index and thickness of the liquid crystal and those of the film satisfy a specific relationship in a non-application of a voltage, an interference reflection is generated.

In these displays, accordingly, it is possible to carry out a reflection type display without using a polarizer.

In the displays disclosed in JP-A-6-308542 (Kokai) and JP-A-7-92483 (Kokai), however, it is impossible to irradiate an interference pattern of a laser beam on a wide region at a time. For this reason, it is necessary to scan and irradiate the interference pattern of the laser beam. Consequently, it is hard to increase a manufacturing efficiency.

In the display disclosed in JP-A-10-228015 (Kokai), moreover, the use of a thin film causes a deterioration in a handling property. For this reason, a manufacture cannot be carried out easily. In addition, it is difficult to uniformly laminate a layer. As a result, a display unevenness is caused easily. On the other hand, when a thick film is used to enhance the handling property of the film, such display becomes dark and a driving voltage is raised. Moreover, JP-A-10-228015 (Kokai) has disclosed a technique for rolling a lamination of a thick film and a liquid crystal, thereby reducing a thickness of the film. However, it is difficult to roll the film interposing a liquid crystal having a fluidity while uniformly regulating a thickness of each layer.

### SUMMARY OF THE INVENTION

The invention may provide a liquid crystal display including a pair of substrates having main surfaces respectively, the main surfaces facing on each other; a polymer layer interposed between the pair of substrates, the polymer layer including a block copolymer having a liquid crystalline side chain and having a periodic structure in a perpendicular direction to the main surfaces; and a controller that controls a light reflectance of the polymer layer by applying a voltage to the polymer layer.

### BRIEF DESCRIPTION OF THE DRAWINGS

Embodiment may be described in detail with reference to the accompanying drawings, in which:

FIG. 1 is a plan view showing a schematic structure of a liquid crystal display according to one embodiment of the invention,

FIG. 2 is a sectional view partially showing the schematic structure of the liquid crystal display in FIG. 1;

FIG. 3 is a sectional view typically showing a structure of a polymer layer in a non-application of a voltage;

FIG. 4 is a sectional view typically showing the structure of the polymer layer in an application of the voltage; and

FIG. 5 is a sectional view showing a schematic structure of a liquid crystal display according to another embodiment of the invention.

### DETAILED DESCRIPTION OF THE INVENTION

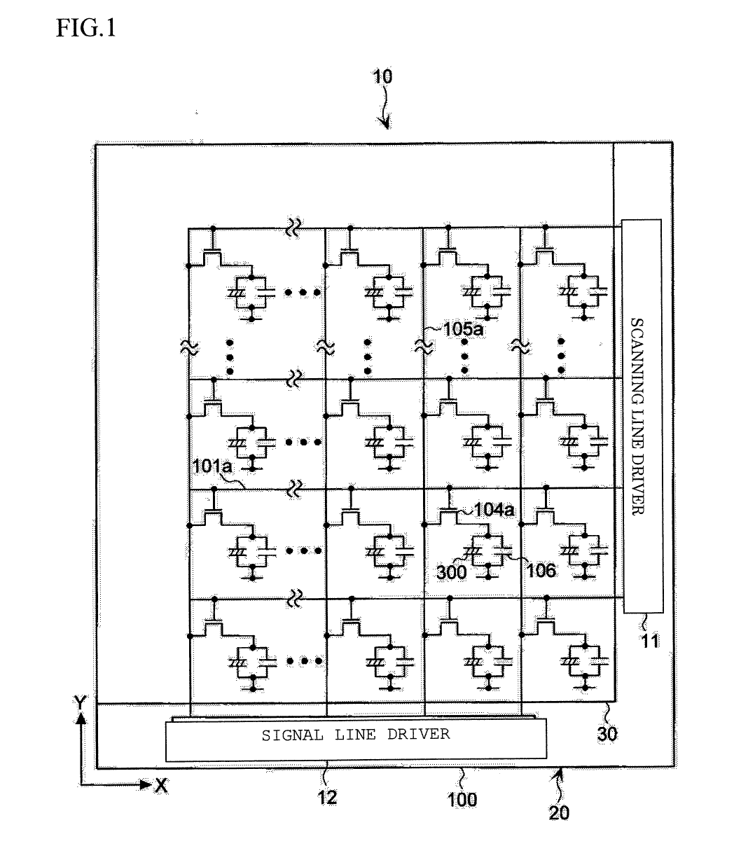

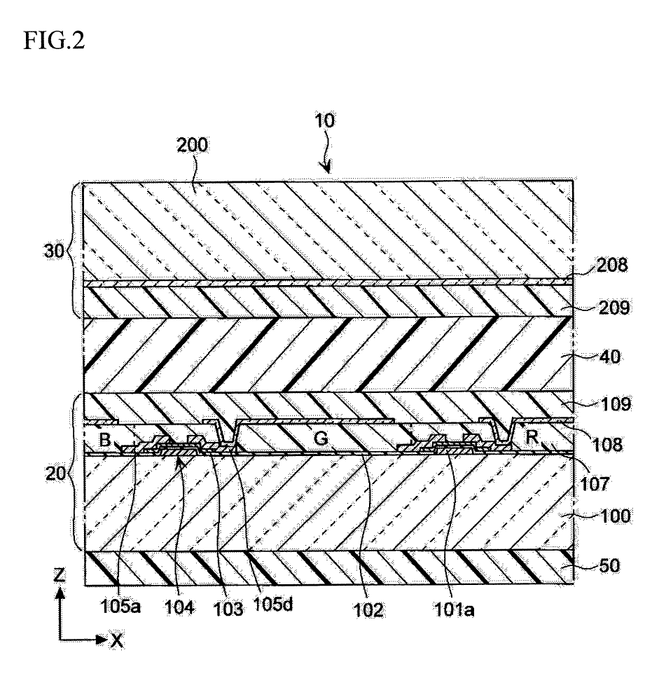

Embodiments according to the invention will be described below in detail with reference to the drawings. FIG. 1 is a plan view illustrating a schematic structure of a liquid crystal display according to the invention and FIG. 2 is a sectional view partially illustrating the schematic structure of the liquid crystal display in FIG. 1.

The liquid crystal display is of an active matrix type a reflection type display, and comprises a liquid crystal display panel 10, a scanning line driver 11 connected to the liquid crystal display panel 10, and a signal line driver 12.

The liquid crystal display panel 10 has an array substrate 20 and a faced substrate 30, and a frame-shaped seal layer (not shown) is provided between the array substrate 20 and the faced substrate 30. A space surrounded by the array substrate 20, the faced substrate 30 and the seal layer which is not shown is filled with a block copolymer having a liquid crystalline side chain and a polymer layer 40 is formed. Moreover, a light absorbing film 50 is stuck to the array substrate 20 and a user sees the liquid crystal display panel 10 from an external surface side of the faced substrate 30.

The array substrate 20 has a transparent substrate 100 such as a glass substrate or a plastic substrate , a scanning line 101 provided over the transparent substrate 100, and a storage capacitor line (not shown), for example. The scanning line 101 and the storage capacitor line are extended in an X direction respectively and are alternately arranged at regular intervals in a Y direction which is orthogonal to the X direction.

The scanning line 101 and the storage capacitor line can be formed at the same step. Moreover, a metal or an alloy can be used as these materials, for example. The scanning line 101 and the storage capacitor line are covered with an insulating film 102, and a silicon oxide film can be used as the insulating film 102, for example.

A semiconductor layer 103 is provided on the insulating film 102 corresponding to a gate electrode of the scanning line 101. The semiconductor layer 103 is formed of amorphous silicon, for example, and crosses the gate electrode. A channel protecting layer which is not shown and an ohmic layer are formed on the semiconductor layer 103.

The gate electrode, the semiconductor layer 103 and a gate insulating film (that is, a portion positioned between the gate electrode of the insulating film 102 and the semiconductor layer 103) form a thin film transistor. The thin film transistor is utilized as a pixel switch 104. In the example, the pixel switch 104 is an n-channel thin film transistor, and more specifically, an amorphous silicon thin film transistor. However, the pixel switch 104 is not restricted thereto but a polysilicon thin film transistor may be used or another switching unit such as a thin film diode may be used in place of the use of the thin film transistor.

Furthermore, a signal line 105a and a source electrode 105b are provided on the insulating film 102. Each signal line 105a is extended in the Y direction and is arranged in the X direction corresponding to a column formed by the pixel switch 104. The signal line 105a covers a drain of the semiconductor layer 103 included in the pixel switch 104. More specifically, a part of the signal line 105a functions as a drain electrode of the pixel switch 104. The source electrode 105b is provided corresponding to the pixel switch 104 and functions as a source electrode of the pixel switch 104, and furthermore, faces the storage capacitor line. The source electrode 105b, the storage capacitor line and the insulating film 102 provided therebetween form a capacitor 106.

A color filter 107 is further provided on the insulating film 102. The color filter 107 includes layers having blue (B), green (G) and red (R) colors, for example. Moreover, a pixel electrode 108 is provided on the color filter 107. The pixel electrode 108 is connected to the source electrode 105b via a through hole formed on the color filter 107. For example, ITO (indium tin oxide) can be used as a material of the pixel electrode 108. The pixel switch 104, the source electrode 105b, the pixel electrode 108 and the capacitor 106 form a pixel circuit.

The pixel electrode 108 is covered with an alignment film 109. As will be described below, the polymer layer 40 carries out a micro-phase separation to form a periodic structure. In this case, the alignment film 109 functions to form a periodic structure in which an A polymer chain (a first medium layer) 301 and a B polymer chain (a second medium layer) 302 are arranged alternately in a perpendicular direction to the main surface of the array substrate 20. In the case in which a comparatively hydrophilic film such as polyimide, nylon, polyamide, benzocyclobutene polymer or polyacrylonitrile is used for the alignment film 109, either the A polymer chain or the B polymer chain which is more hydrophilic is arranged to come in contact with the alignment film. Assuming that the A polymer chain is more hydrophilic, the periodic structure is formed in such a manner that the A polymer chain is arranged on the orientation film 109, the B polymer chain is arranged thereon, and the A polymer chain is arranged thereon. To the contrary, in the case in which a hydrophobic film such as a silane coupling agent is used for the alignment film 109, either the A polymer chain or the B polymer chain which is more hydrophobic is arranged to come in contact with the alignment film. The polyimide is excellent in an easiness of film formation and a chemical stability. If an oil mist is not adsorbed into the pixel electrode 108 and a counter electrode 208 and a hydrophilic surface is formed uniformly, the alignment film 109 and an alignment film 209 are not indispensable to the invention and can also be omitted.

A scanning signal input terminal group (not shown) and a video signal input terminal group (not shown) are further disposed on the insulating film 102. The scanning signal input terminal and the video signal input terminal are connected to the scanning line 101 and the signal line 105a, respectively. For example, a metal or an alloy can be used as materials of these terminals. The insulating film 102, the semiconductor layer 103, the color filter 107 and the orientation film 109 are components of the array substrate 20.

The faced substrate 30 has a transparent substrate 200 such as a glass substrate or a plastic substrate, the counter electrode 208 provided over the transparent substrate 200, and the alignment film 209 covering the counter electrode 208. The counter electrode 208 is a common electrode facing the pixel electrode 108. ITO can be used for a material of the counter electrode 208, for example. The same film as the orientation film 109 can be used as the alignment film 209.

The array substrate 20 and the faced substrate 30 are disposed with the alignment films 109 and 209 facing each other. The scanning signal input terminal and the video signal input terminal which are not shown are provided between the array substrate 20 and the faced substrate 30, and are provided on an outside of a frame-shaped seal layer sticking the array substrate 20 and the faced substrate 30 to each other. An epoxy or acryl type adhesive can be used as a material of the frame-shaped seal layer.

A transfer electrode (not shown) is disposed on an outside of a frame formed by the frame-shaped seal layer between the array substrate 20 and the faced substrate 30. The transfer electrode connects the counter electrode 208 to the array substrate 20.

A spherical shape spacer is provided between the array substrate 20 and the faced substrate 30 or the array substrate 20 or/and the faced substrate 30 include(s) a columnar spacer. These spacers form a gap having an almost constant thickness in a position corresponding to the pixel electrode 108 between the array substrate 20 and the faced substrate 30.

A space surrounded by the array substrate 20, the faced substrate 30 and the frame-shaped seal layer is filled with a block copolymer having a liquid crystalline side chain and forms the polymer layer 40. The pixel electrode 108, the counter electrode 208, the alignment film 109, the alignment film 209 and the polymer layer 40 form a liquid crystal unit 300. Each pixel of the liquid crystal display panel 10 includes the pixel switch 104, the liquid crystal unit 300 and the capacitor 106. Moreover, the array substrate 20, the faced substrate 30 and the polymer layer 40 and the frame-shaped seal layer which are provided therebetween form a liquid crystal cell.

The light absorbing film 50 is a black plastic film, for example.

The scanning line driver 11 and the signal line driver 12 are connected to the scanning signal input terminal and the video signal input terminal, respectively. The scanning line driver 11 and the signal line driver 12 may be subjected to COG (chip on glass) mounting or TCP (tape carrier package) mounting as shown in FIG. 1.

Next, a structure of the polymer layer 40 will be described in detail. The block copolymer constituting the polymer layer 40 indicates a straight chain copolymer obtained by bonding a plurality of homopolymer chains as a block. Examples of the block copolymer include an A-B type diblock copolymer having a structure of—(AA..AA)—(BB..BB)—in which ends of the A polymer chain (the first medium layer) 301 having a repetitive unit A and the B polymer chain (the second medium layer) 302 having a repetitive unit B are bonded to each other.

Such a block copolymer can be synthesized by various polymerizing methods, and a living polymerizing method is the most preferable. In the living polymerizing method, a living a nion polymerizing method or a living cation polymerizing method can start a polymerization for a kind of monomer with a polymerization initiator for generating an anion or a cation and can successively add other monomers, thereby synthesizing the block copolymer. Also in a living radical polymerizing method, moreover, it is possible to synthesize the block copolymer. In these various living polymerizing methods, it is possible to precisely control a molecular weight and a copolymer ratio, thereby obtaining a block copolymer having a small molecular weight distribution. When using the living polymerizing method, it is preferable to sufficiently dry a solvent with a drying agent such as metal sodium, thereby preventing a mixture of oxygen by a method of freeze drying or bubbling of an inert gas. It is preferable that a polymerizing reaction should be carried out on pressurizing conditions of two hectopascals or more under an inert gas current. The polymerization on the pressurizing conditions has an advantage that a mixture of water or oxygen from an outside of a reacting container can be effectively prevented and a reacting process can be executed at a comparatively low cost. A chemical bond of polymer chains is preferably a covalent bond in respect of a bonding strength. In particular, the chemical bond is more preferably a carbon—carbon bond or a carbon—silicon bond.

By carrying out a heat treatment (annealing) over the block copolymer, it is possible to generate a micro-phase separation in which a layer formed by the A polymer chain and a layer formed by the B polymer chain are arranged alternately. By utilizing the micro-phase separation for the polymer layer 40, therefore, there is formed the periodic structure in which the A polymer chain and the B polymer chain are arranged alternately in the perpendicular direction to the main surface of the array substrate 20. Such a periodic structure is generated most often when a composition ratio of the A polymer chain and the B polymer chain is 50:50. Practically, it is preferable that the composition ratio should be in a range of 40:60 to 60:40. In the case in which a polar difference between the A polymer chain and the B polymer chain is great, that is, one of the polymer chains is greatly hydrophilic and the other polymer chain is greatly hydrophobic, moreover, such a periodic structure is formed easily. A polarity of the polymer chain can set a solubility parameter to be an index, and it is preferable that a difference in the solubility parameter between an A polymer chain material and a B polymer chain material should be equal to or greater than 5 (MPa) ^{1/2}. In the case in which the difference in the solubility parameter between the A polymer chain material and the B polymer chain material is smaller than 5 (MPa) ^{1/2}, the periodic structure is formed with difficulty.

The periodic structure can be formed through the micro-phase separation of the block copolymer by dissolving the block copolymer into a proper solvent to prepare a coating solution, applying the coating solution onto a substrate and carrying out drying to form a film, and annealing the film at a temperature which is equal to or higher than a glass transfer temperature of the block copolymer. Moreover, it is also possible to mutually crosslink polymers constituting the block copolymer three-dimensionally by carrying out addition of a crosslinking agent or introduction of a crosslinking group to the block copolymer forming the micro-phase separating structure. By the crosslinking treatment, it is possible to enhance and stabilize a heat resistance and a mechanical strength of the micro-phase separating structure.

It is desirable that the solvent for dissolving the block copolymer should be good for two types of polymer chain materials constituting the block copolymer. A repulsive force of the polymer chains is proportional to a square of a difference in a solubility parameter between the two types of polymer chain materials. By using a good solvent for the two types of polymer chain materials, therefore, the difference in the solubility parameter between the two types of polymer chain materials is decreased and a free energy of a system is reduced to be advantageous for a phase separation.

For a basic backbone of the block copolymer to be used in the liquid crystal display panel 10, for example, it is possible to use a combination of two of such polymers as polystyrene, polymethacrylate, polyisoprene, polybutadiene, polydimethylsiloxane and these derivatives. These materials are preferable because they can easily form an A-B type diblock copolymer. In particular, the polymethacrylate is suitable because it can easily bond a liquid crystalline side chain to an ester portion. The material has a comparatively high refractive index. By combining the same material with a material having a low refractive index such as polydimethylsiloxane, it is possible to obtain a high reflectance.

Examples of these derivatives include poly α—methylstyrene, poly t—butylstyrene, polytrifluoroethyl methacrylate and polymethylphenylsiloxane.

In the case in which a thin film of the block copolymer is fabricated, moreover, it is preferable to use, as a solvent for dissolving the block copolymer, a solvent having a boiling point of 150° C. or more, for example, ethylcellosolve acetate, propyleneglycol monomethylether acetate and ethyl lactate in such a manner that a uniform solution can be prepared.

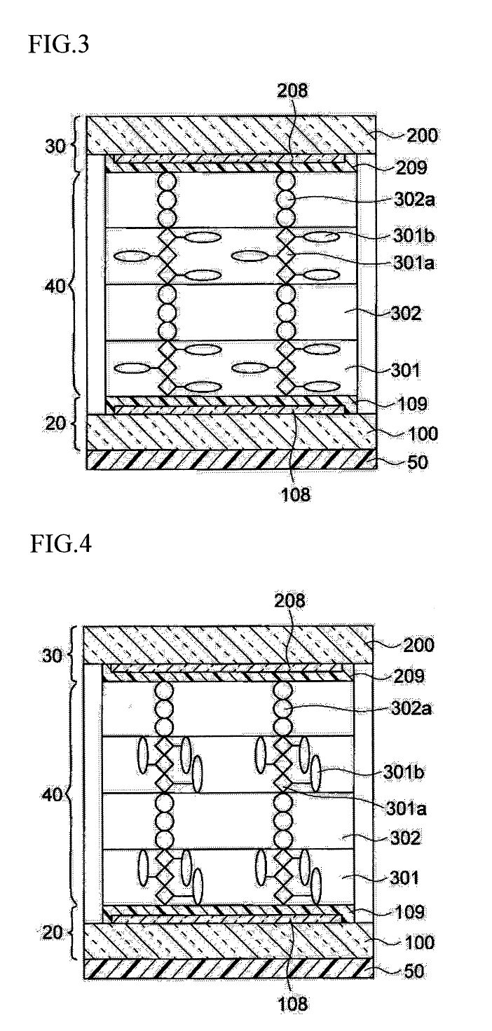

Assuming that the polymer layer 40 is formed of an A-B type diblock copolymer having a micro-phase separating structure in order to describe the principle of the operation of the liquid crystal display panel 10 according to the invention, next, FIG. 3 is a sectional view typically showing a structure of a polymer layer formed of the A-B type diblock copolymer in a non-application of a voltage and FIG. 4 is a sectional view typically showing a structure of the polymer layer in an application of a voltage. The micro-phase separating structure of the A-B type diblock copolymer is a periodic structure in which the first medium layer (hereinafter referred to as an “A polymer layer”) 301 constituted by an A polymer chain 301a and a liquid crystalline side chain 301b bonded to the A polymer chain 301a and the second medium layer (hereinafter referred to as a “B polymer layer”) 302 constituted by a B polymer chain 302a are alternately arranged in a perpendicular direction to a main surface (a substrate surface) of a substrate (that is, the array substrate 20 and the faced substrate 30).

A refractive index of the A polymer layer 301 in the non-application of the voltage is indicated as n₁, a refractive index in the application of the voltage is indicated as n₁′, and a refractive index of the B polymer layer 302 is indicated as n₂. If n₁, is different from n₂, a reflection is generated on an interface of the A polymer layer 301 and the B polymer layer 302. A reflectance depends on a difference between n₁ and n₂ by the Snell's law. In the case in which the difference in the refractive index is approximately 0.2, for example, a practically sufficient reflectance can be obtained if the numbers of the A polymer layers 301 and the B polymer layers 302 are equal to or greater than ten, respectively.

In the application of the voltage, the liquid crystalline side chain 301b of the A polymer layer 301 is orientated in parallel with an electric field so that the refractive index of the A polymer layer 301 is changed from n₁ to n₁′. If a material of the B polymer layer 302 is selected in such a manner that n₁′ is almost equal to n₂, the reflection on the interface of the A polymer layer 301 and the B polymer layer 302 is eliminated so that a light is transmitted through the polymer layer 40. The transmitted light is absorbed by the light absorbing film so that a black display can be obtained. Moreover, the principle of the operation of the liquid crystal display panel 10 according to the invention is not restricted to the principle of the operation described above but a reverse operation may be carried out, for example. More specifically, by selecting the material of the B polymer layer 302 in such a manner that the refractive index n₁ of the A polymer layer 301 and the refractive index n₂ of the B polymer layer 302 in the non-application of the voltage are almost equal to each other, the reflection on the interface of the A polymer layer 301 and the B polymer layer 302 is eliminated so that the light is transmitted through the polymer layer 40. By absorbing the transmitted light through the light absorbing film, it is possible to obtain a black display. In the application of the voltage, furthermore, the refractive index n₁, of the A polymer layer 301 is changed into n₁′. If n₁′ is different from n₂, the reflection is generated on the interface of the A polymer layer 301 and the B polymer layer 302. A reflectance depends on a difference between n₁ and n₂ by the Snell's law. In the case in which the difference in the refractive index is approximately 0.2, for example, a practically sufficient reflectance can be obtained if the numbers of the A polymer layers 301 and the B polymer layers 302 are equal to or greater than ten, respectively.

If conditions of n₁·d₁=λ/4 (d₂ represents a thickness of the A polymer layer 301) and n₂·d₂ =λ/4 (d₂ represents a thickness of the B polymer layer 302) are satisfied at the same time for a predetermined wavelength λ, a light having the wavelength λ is subjected to an interference reflection. By utilizing the characteristic, it is possible to carry out a reflection display of a specific color without using a color filter.

It is preferable that the polymer layer 40 should have a pitch of a periodic structure (that is, a total thickness of the A polymer layer 301 and the B polymer layer 302) which is 5 nm to 200 nm and a repetitive number of 10 to 1000 in order to obtain excellent reflecting and transmitting properties.

Next, description will be given to a method of manufacturing the liquid crystal display. The faced substrate 30 provided with the counter electrode 208 and the alignment film 209 is prepared, and a solution containing a block copolymer having a liquid crystalline side chain is applied onto the orientation film 209. Subsequently, the substance thus obtained is heated to volatilize a solvent contained in the solution, thereby forming the polymer layer 40. The polymer layer 40 is heated for a certain period of time in a nitrogen atmosphere, thereby phase-separating the block copolymer. Thus, there is formed a periodic structure in which two types of polymer layers formed by two types of polymer chains constituting the block copolymer respectively are arranged alternately in a perpendicular direction to the substrate surface of the faced substrate 30. Subsequently, there is prepared the array substrate 20 in which the pixel switch 104 and the color filter 107 are fabricated. A seal layer is formed in an outer peripheral portion of the array substrate 20 and is stuck to the faced substrate 30 on which the polymer layer 40 is formed. By carrying out a pressurization in this state to cure the seal layer, a liquid crystal cell is obtained. Then, the light absorbing film 50 is stuck to a liquid crystal cell. By mounting a scanning line driver 2 and a signal line driver 3 thereon and attaching a liquid crystal display panel 1 to a housing, furthermore, a liquid crystal display is finished.

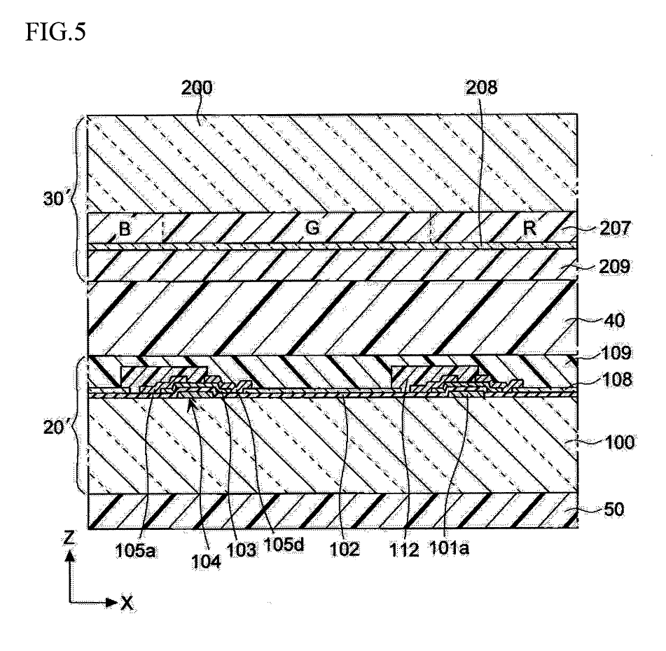

Next, description will be given to another embodiment according to the invention. FIG. 5 is a sectional view partially illustrating a schematic structure of another liquid crystal display according to the invention. In the liquid crystal display shown in FIG. 5, the color filter 107 is omitted from the array substrate 20 constituting the liquid crystal display shown in FIGS. 1 and 2. Instead, there is used an array substrate 20′ having a structure in which a black matrix 112 is disposed between a signal line 105a and an alignment film 109. Other portions have almost the same structures as those in the liquid crystal display shown in FIGS. 1 and 2. More specifically, the liquid crystal display shown in FIGS. 1 and 2 is a display for a color display having a color filter on array structure. On the other hand, the liquid crystal display shown in FIG. 5 is a display for a monochromatic display having a black matrix on array structure. Any of them can be employed.

### EXAMPLE

Examples according to the invention will be described below.

### Example 1

As an example, the liquid crystal display shown in FIG. 1 was fabricated by the following method. In order to fabricate the array substrate 20, first of all, the scanning line 101 and a storage capacitor line which is not shown were formed on a glass board to be the transparent substrate 100. Chromium was used for materials of these lines. Next, these lines were covered with the insulating film 102 having a laminating structure of a chromium oxide film and a silicon oxide film. Subsequently, the semiconductor layer 103 formed of amorphous silicon was provided on the insulating film 102 and was subjected to patterning. Then, a channel protecting layer (not shown) formed of silicon nitride was provided on the semiconductor layer 103 and an ohmic layer (not shown) was formed on the semiconductor layer 103 and the channel protecting layer.

Next, the signal line 105a, the source electrode 105b, a scanning signal input terminal (not shown) and a video signal input terminal (not shown) were formed on the insulating film 102. Thereafter, the color filter 107 having a contact hole was further formed on the insulating film 102 by photo lithography and the pixel electrode 108 was then formed.

After the pixel electrode 108 was cleaned, it was coated with a polyimide solution (produced by NISSAN CHEMICAL INDUSTRIES, LTD. SE-5291) by offset printing and the coated film was heated at 90° C. for one minute by using a hotplate, and furthermore, was heated at 200° C. for 30 minutes so that the alignment film 109 was formed.

On the other hand, in order to fabricate the faced substrate 30, the ITO was sputtered onto the glass board to be the transparent substrate 200, thereby forming the counter electrode 208, and the counter electrode 208 was cleaned and the alignment film 209 was then formed by the same method as the method of forming the orientation film 109.

Next, a block copolymer (poly(dimethylsiloxane-b-6-(4′-cyanobiphenyl-4-yloxy)hexyl methacrylate) of a substance (PLC) obtained by ester bonding a liquid crystalline side chain to polymethacrylate and dimethylsiloxane (DS) was dissolved in propyleneglycol monomethylether acetate (PGMEA) to be a solvent, and a polymer solution was thus prepared. A molecular weight of the PLC in the block copolymer is 8000 and that of the DS is 8500, and Mw/Mn is 1.15. The polymer solution was applied onto the alignment film 209 of the opposed substrate 30 at a rotating speed of 2500 rpm by a spin coating method so that a coated film was obtained. This was heated at 110° C. for 90 seconds to volatilize a (prebaking) solvent, and annealing was then carried out at 210° C. for four hours in a nitrogen atmosphere to micro-phase separate the PLC and the DS in the block copolymer, thereby forming the polymer layer 40 having a thickness of 5 μm.

Thereafter, an epoxy adhesive was applied to the outer peripheral portion of the faced substrate 30 by using a dispenser in order to surround the alignment film 209. Subsequently, the array substrate 20 and the faced substrate 30 were disposed in such a manner that the alignment films 109 and 209 face each other, and were aligned and stuck to each other, and the epoxy adhesive was cured in a pressurizing state, thereby forming a frame-shaped seal layer.

Next, the light absorbing film 50 having a black color was stuck to the external surface of the array substrate 20. Furthermore, the scanning line driver 11 and the signal line driver 12 were connected to the array substrate 20 so that the liquid crystal display was fabricated.

The liquid crystal display could display a bright image having no display unevenness. Furthermore, the liquid crystal display did not cause the display unevenness also after a continuous lighting test was carried out for 3000 hours at any of temperatures, that is, 0° C., 25° C. or 50° C.

### Example 2

As an example, the liquid crystal display shown in FIG. 5 was fabricated by the following method. In order to fabricate the array substrate 20′, first of all, the scanning line 101 and a storage capacitor line which is not shown were formed on a glass substrate to be the transparent substrate 100. Chromium was used for materials of these lines. Next, these lines were covered with the insulating film 102 having a laminating structure of a chromium oxide film and a silicon oxide film. Subsequently, the semiconductor layer 103 formed of amorphous silicon was provided on the insulating film 102 and was subjected to patterning. Then, a channel protecting layer (not shown) formed of silicon nitride was formed on the semiconductor layer 103 and an ohmic layer (not shown) was formed on the semiconductor layer 103 and the channel protecting layer.

Next, the signal line 105a, the source electrode 105b, a scanning signal input terminal (not shown) and a video signal input terminal (not shown) were formed on the insulating film 102. Thereafter, the pixel electrode 108 was further formed on the insulating film 102. After the pixel electrode 108 was cleaned, it was coated with a polyimide solution (produced by NISSAN CHEMICAL INDUSTRIES, LTD. SE-5291) by offset printing and the coated film was heated at 90° C. for one minute by using a hotplate, and furthermore, was heated at 200° C. for 30 minutes so that the alignment film 109 was formed.

On the other hand, in order to fabricate the faced substrate 30, the ITO was sputtered onto the glass board to be the transparent substrate 200, thereby forming the counter electrode 208, and furthermore, a columnar spacer having a height of 5 μm and a bottom face of 5 μm×10 μm was formed on the counter electrode 208 by utilizing a photolithographic process so as to be positioned on the signal line 105a when the array substrate 20 and the faced substrate 30 were stuck to each other. After the counter electrode 208 was cleaned, the alignment film 209 was formed by the same method as the method of forming the alignment film 109.

Next, a block copolymer (poly(dimethylsiloxane-b-6-(4′-cyanobiphenyl-4-yloxy)hexyl methacrylate) of a substance (PLC) obtained by ester bonding a liquid crystalline side chain to polymethacrylate and dimethylsiloxane (DS) was dissolved in propyleneglycol monomethylether acetate (PGMEA) to be a solvent, and a polymer solution was thus prepared. A molecular weight of the PLC in the block copolymer is 8000 and that of the DS is 8500, and Mw/Mn is 1.15. The polymer solution was applied onto the alignment film 209 of the faced substrate 30 at a rotating speed of 2500 rpm by a spin coating method so that a coated film was obtained. This was heated at 110° C. for 90 seconds to volatilize a (prebaking) solvent, and annealing was then carried out at 210° C. for four hours in a nitrogen atmosphere to micro-phase separate the PLC and the DS in the block copolymer, thereby forming the polymer layer 40 having a thickness of 5 μm.

Thereafter, an epoxy adhesive was applied to the outer peripheral portion of the opposed substrate 30 by using a dispenser in order to surround the alignment film 209. Subsequently, the array substrate 20 and the faced substrate 30 were disposed in such a manner that the alignment films 109 and 209 face each other, and were aligned and stuck to each other, and the epoxy adhesive was cured in a pressurizing state, thereby forming a frame-shaped seal layer.

Next, the light absorbing film 50 having a black color was stuck to the external surface of the array substrate 20. Furthermore, the scanning line driver 11 and the signal line driver 12 were connected to the array substrate 20 so that the liquid crystal display was fabricated.

The liquid crystal display could display a bright image having no display unevenness. Furthermore, the liquid crystal display did not cause the display unevenness also after a continuous lighting test was carried out for 3000 hours at any of temperatures, that is, 0° C., 25° C. or 50° C.

While the embodiments and the examples according to the invention have been described above, the invention is not restricted to such configurations but various changes can be made without departing from the technical thought of the invention.

What is claimed is:

1. A liquid crystal display comprising:
a pair of substrates having surfaces respectively, the surfaces facing on each other;
a polymer layer interposed between the pair of substrates, the polymer layer including a block copolymer having a liquid crystalline side chain, the block copolymer having a periodic structure in a perpendicular direction to the surfaces; and
a controller that controls a light reflectance of the polymer layer by applying a voltage to the polymer layer.

2. The liquid crystal display according to claim 1, wherein the polymer layer includes a first medium layer and a second medium layer, each including the block copolymer, the first medium layer and the second medium layer being alternately present in the perpendicular direction;
the first medium layer has a refractive index n₁, in the perpendicular direction;
the second medium layer has a refractive index n₂ in the perpendicular direction; and
a difference between the refractive index n₁, and the refractive index n₂ changes when the voltage is applied to the polymer layer.

3. The liquid crystal display according to claim 2,
wherein the refractive index n₁ and the refractive index n₂ are different from each other when the voltage is not applied to the polymer layer; and
the refractive index n₁ and the refractive index n₂ are substantially equal to each other when the voltage is applied to the polymer layer.

4. The liquid crystal display according to claim 1,
wherein the refractive index n₁ and the refractive index n₂ are substantially equal to each other when the voltage is not applied to the polymer layer; and
the refractive index n₁ and the refractive index n₂ are different from each other when the voltage is applied to the polymer layer.

5. The liquid crystal display according to claim 1,
wherein the periodic structure has a pitch of 5 nm to 200 nm and the number of repetitions of 10 to 1000.

6. The liquid crystal display according to claim 2,
wherein the first medium layer includes a polyester methacrylate having the liquid crystalline side chain or a derivative thereof; and
the second medium layer includes a dimethylsiloxane or a derivative thereof.

7. A method of manufacturing a liquid crystal display comprising:
applying a solution containing a block copolymer having a liquid crystalline side chain on a first substrate;
forming a polymer layer containing the block copolymer on the first substrate by volatilizing a solvent contained in the solution;
performing an annealing treatment over the polymer layer to phase-separate the block copolymer; and
sticking a second substrate to the first substrate having the phase-separated polymer layer formed thereon.

8. The method according to claim 6, further comprising:
obtaining the block copolymer by living polymerizing polyestermethacrylate having the liquid crystalline side chain or a derivative thereof and dimethylsiloxane or a derivative thereof.
